(19) United States
(12) Patent Application Publication
(10) Pub. No.: US 2026/0286860 A1
(43) Pub. Date: Sep. 24, 2026

(54) CASING FOR AN AIRCRAFT TURBINE ENGINE

(71) Applicant: SAFRAN AIRCRAFT ENGINES, Paris (FR)

(72) Inventors: Frédéric Jacques Eugène GOUPIL, MOISSY-CRAMAYEL (FR); Christophe Paul JACQUEMARD, MOISSY-CRAMAYEL (FR); Didier Gabriel Bertrand DESOMBRE, MOISSY-CRAMAYEL (FR)

(73) Assignee: SAFRAN AIRCRAFT ENGINES, Paris (FR)

(21) Appl. No.: 19/477,929

(22) PCT Filed: Apr. 25, 2024
(86) PCT No.: PCT/FR2024/050549

§ 371 Date: Oct. 23, 2025

(30) Foreign Application Priority Data
Apr. 28, 2023 (FR) FR2304304

(51) Int. Cl. F01D 25/18; F01D 25/24

(52) U.S. Cl. CPC F01D 25/18; F01D 25/24; F05D 2240/14; F05D 2260/98

(57) ABSTRACT

A casing includes an inner annular shroud that internally defines a lubrication chamber and an outer annular shroud. An arm extends radially between the inner and outer annular shrouds and includes an inner cavity provided with a first compartment that opens into the lubrication chamber through an oil inlet provided in the inner shroud and a second compartment. The second compartment is separated from the lubrication chamber by a cover that extends longitudinally inside the lubrication chamber from the second annular edge of the inner annular shroud to the oil inlet. The oil inlet is circumferentially bounded by first and second walls which extend radially from the inner shroud on either side of the oil inlet.

### TECHNICAL FIELD OF THE INVENTION

The invention relates to the field of the casings for aircraft turbine engines.

More specifically, the invention relates to the field of the casings defining a lubrication enclosure, for the turbine engines comprising a lubrication system for a speed reducer, comprising main and auxiliary lubrication circuits.

### TECHNICAL BACKGROUND

The prior art is illustrated by the document US-A1-2006/042223.

An aircraft turbine engine typically comprises, from upstream to downstream in the direction of gas flow, a fan mobile in rotation about a longitudinal axis, a low-pressure compressor, a high-pressure compressor, a combustion chamber, a high-pressure turbine, a low-pressure turbine and a gas exhaust nozzle.

The fan allows the suction of an air flow divided into a primary flow and a secondary flow. The primary flow passes through a primary duct of the turbine engine while the secondary flow is directed towards a secondary duct surrounding the primary duct.

The turbine engine also comprises an inlet casing centered on the longitudinal axis and defining the inlet to the primary duct. The inlet casing comprises an annular inner shell surrounded by an annular outer shell connected by radial arms.

The primary flow is compressed downstream in the compressors. The compressed air is then mixed with a fuel and burned within the combustion chamber. The gases resulting from the combustion pass through the turbines then escape through the nozzle whose cross-section allows the acceleration of these gases to generate the propulsion.

The rotor of the low-pressure turbine is connected to the rotor of the low-pressure compressor by a low-pressure shaft and the rotor of the high-pressure turbine is connected to the rotor of the high-pressure compressor by a high-pressure shaft. In addition, the fan is driven in rotation by a fan shaft which is connected to the low-pressure shaft by a speed reducer, allowing the fan to be driven at a lower rotational speed than the rotational speed of the low-pressure shaft. The speed reducer is typically arranged in a lubrication enclosure for lubricating the speed reducer. The lubrication enclosure is typically located inside the inner shell.

To ensure the lubrication of the speed reducer in the lubrication enclosure, the turbine engine also comprises a main lubrication circuit of the speed reducer connected to the lubrication enclosure. The main circuit comprises an oil supply pump of the reducer connected to a main oil reservoir. The oil supply pump is typically driven in rotation by the high-pressure shaft by means of an accessory gearbox.

During certain operating phases of the turbine engine, such as the free rotation phases of the fan (referred to as “windmilling”) during which the fan shaft is driven in rotation thus driving the low-pressure shaft, the rotational speed of the high-pressure shaft is insufficient to drive the supply pump at a speed sufficient to provide the flow rate required to lubricate the reducer. However, it is necessary to ensure lubrication of the speed reducer even during these operating phases of the turbine engine.

In this context, the turbine engine comprises an auxiliary lubrication circuit for the reducer. The auxiliary circuit typically comprises an auxiliary pump supplied with energy by an electric generator, for example, or driven by the low-pressure shaft, which allows the auxiliary pump to be primed even in the event of free rotation of the fan and low rotational speed of the high-pressure shaft.

In order to supply the auxiliary circuit with oil, the document FR-A1-3 075 875 proposes recovering the oil flowing by gravity into the bottom of the enclosure. To this end, one of the radial arms located at 6 o'clock has an inner cavity opening into the enclosure through an oil inlet. The arm also has a first oil outlet connected to the main circuit by a first pipe and a second oil outlet connected to the auxiliary circuit by a second pipe. The first pipe is connected to an oil recovery pump supplying the main reservoir and the second pipe is connected to an auxiliary pump in the auxiliary circuit.

In addition, according to this document, a radial bulkhead is arranged in the inner cavity and delimits an upstream compartment and a downstream compartment, the second pipe being connected to the upstream compartment and the first pipe being connected to the downstream compartment.

So, for example, during phases of free rotation of the fan when the supply pump is not primed, the auxiliary pump sucks the oil flowing by gravity into the arm located at 6 o'clock through the second pipe. The auxiliary circuit may therefore be supplied with oil to lubricate the reducer during these phases.

Although this solution provides a volume of oil for auxiliary lubrication of the speed reducer in the event of free rotation of the fan, for example, the volume of oil available for these operating phases may be increased. Indeed, this document teaches that to maximize oil recovery, the oil inlet has a maximum axial dimension extending over the entire axial width of the arm, defined between upstream and downstream edges of the arm. The combination of the oil inlet configuration and the radial wall hinders an optimum oil recovery in the first pipe. In fact, the oil flowing down the arm by gravity supplies both the upstream compartment and the downstream compartment. The main circuit may therefore be supplied with oil even though the auxiliary circuit does not have maximum volume during the free rotation phases of the fan. During these phases, although the lubrication of the reducer is guaranteed, it may be optimized.

There is therefore a need to provide a solution for optimizing the lubrication of the speed reducer during all the phases of the turbine engine operation.

### SUMMARY OF THE INVENTION

To this end, the invention proposes a casing for an aircraft turbine engine, the casing extending around a longitudinal axis, and comprising:
an inner annular shell centered on the longitudinal axis and internally defining a lubrication enclosure, the inner annular shell having first and second axially opposed annular edges,
an outer annular shell arranged coaxially around the inner annular shell, arms extending radially between the inner and outer annular shells, one of the arms, called 6 h arm, being tubular and located at 6 h, this 6 h arm comprising:
   a radially external end connected to the outer shell and a radially internal end connected to the inner shell,
   an inner cavity comprising a first compartment opening into the lubrication enclosure via an oil inlet provided in the inner shell, and a second compartment,
   a first oil outlet located in the second compartment,
   a second oil outlet located in the first compartment, the first and second oil outlets being radially offset from the radially internal end.

The casing according to the invention is remarkable in that the second compartment is separated from the lubrication enclosure by a cover extending longitudinally in the lubrication enclosure from the second annular edge to the oil inlet, and in that the oil inlet is delimited circumferentially by first and second walls extending radially from the inner shell on either side of the oil inlet.

Thanks to the cover separating the second compartment of the 6 h arm from the first compartment of the 6 h arm, in combination with the first and second walls delimiting the oil inlet, the oil flows in a privileged manner into the first compartment which is configured to be connected to an auxiliary reservoir of an auxiliary lubrication circuit.

The auxiliary reservoir is therefore supplied with oil as a priority, which ensures a lubrication of the speed reducer when the auxiliary circuit is active.

Thanks to the casing of the invention, a larger volume of oil may be stored in the auxiliary reservoir to supply the auxiliary circuit. The speed reducer may therefore be lubricated optimally, reliably and efficiently during all phases of the turbine engine operation.

The invention may comprise one or more of the following characteristics, taken alone or in combination with each other:
the first and second walls extend longitudinally in the inner shell from the first annular edge to the second annular edge,
the oil inlet is axially delimited by a third wall located between the first and second walls and extending radially into the first compartment,
the third wall extends radially to the second oil outlet,
first and second troughs arranged on either side of the first and second walls and configured to convey the oil from the lubrication enclosure towards the oil inlet,
the first and second troughs extend over an angular sector about the longitudinal axis of between 5° and 10°,
the 6 h arm comprises a radial bulkhead arranged in the inner cavity and separating the first compartment from the second compartment,
the radially external end of the 6 h arm has a bottom wall wherein the second oil outlet is provided, the bulkhead extending radially towards the inside of the 6 h arm from the bottom wall.

The invention also relates to a turbine engine for an aircraft, comprising a casing according to any of the preceding characteristics.

The turbine engine may comprise one or more of the following characteristics, taken singly or in combination:
a fan driven in rotation about the longitudinal axis by a fan shaft,
a low-pressure shaft connected to the fan shaft by a mechanical speed reducer arranged in the lubrication enclosure,
a lubrication system for lubricating the speed reducer comprising a main lubrication circuit and an auxiliary lubrication circuit connected to the lubrication enclosure of the casing, the auxiliary circuit being connected to an auxiliary reservoir, the auxiliary reservoir being located outside the outer shell of the casing, the first oil outlet being connected to the main circuit and the second oil outlet being connected to the auxiliary reservoir,
the auxiliary reservoir is connected directly to the second oil outlet of the casing,
the auxiliary reservoir is housed in an inter-duct compartment which is configured to separate an air flow produced by the fan into a primary flow and a secondary flow.
the inter-duct compartment is located radially between a primary flow duct for the primary flow and a secondary flow duct for the secondary flow.

### BRIEF DESCRIPTION OF THE FIGURES

Further characteristics and advantages will be apparent from the following description of non-limiting embodiments of the invention with reference to the accompanying drawings wherein:

FIG. 1 is a schematic representation in longitudinal cross-section of an aircraft turbine engine according to the invention,

FIG. 2 is a schematic representation in longitudinal cross-section of a speed reducer equipping the turbine engine of FIG. 1,

FIG. 3 is a schematic view of a lubrication system for the speed reducer of FIG. 2, according to one example of embodiment of the invention,

FIG. 4 is a schematic perspective view of a casing according to the invention,

FIG. 5 is another schematic perspective view of the casing shown in FIG. 4,

FIG. 6 is a longitudinal sectional view of the casing shown in FIGS. 4 and 5.

### DETAILED DESCRIPTION OF THE INVENTION

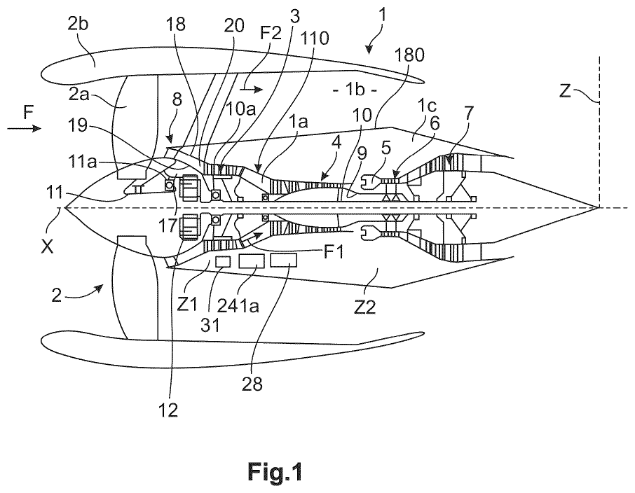

An example of an aircraft turbine engine 1 according to the invention is shown in FIG. 1.

The turbine engine 1 extends around and along a longitudinal axis X.

In this application, the terms “axial”, “axially”, “radial” and “radially” are defined in relation to the longitudinal axis X.

The terms “upstream” and “downstream” are defined in relation to the direction of gas flow in the turbine engine 1 along the longitudinal axis X.

The terms “internal”, “inner”, “external”, “outer” and “exterior” are defined in relation to the distance from the longitudinal axis X along a radial axis Z perpendicular to the longitudinal axis X.

The turbine engine 1 comprises, from upstream to downstream, a fan 2, at least one compressor such as a low-pressure compressor 3 and a high-pressure compressor 4, a combustion chamber 5, at least one turbine such as a high-pressure turbine 6 and a low-pressure turbine 7, and a nozzle for exhausting the gases.

The fan 2 allows the suction of an air flow F divided into a primary flow F1 and a secondary flow F2. The primary flow F1 passes through a primary duct 1a of the turbine engine 1, while the secondary flow F2 is directed towards a secondary duct 1b surrounding the primary duct 1a.

The primary flow F1 is compressed in the low-pressure compressor 3 and then in the high-pressure compressor 4. The compressed air is then mixed with a fuel and burned in the combustion chamber 5. The gases formed by the combustion pass through the high-pressure 6 and the low-pressure 7 turbines. The gases escape finally through the nozzle whose cross-section allows the acceleration of these gases to generate the propulsion.

The fan 2 is mobile in rotation about the longitudinal axis X. The fan 2 comprises vanes 2a evenly distributed around a disk centered on the longitudinal axis X.

The fan 2 is for example ducted. The turbine engine 1 then comprises an annular nacelle 2b centered on the longitudinal axis X surrounding the fan 2. The nacelle 2b, for example, is supported by a fan casing (not shown).

The turbine engine 1 also comprises a casing 8. The casing 8 is, for example, an inlet casing. The casing 8 is located inside the nacelle 2b, for example. The casing 8, for example, is arranged axially between the fan 2 and the low-pressure compressor 3. The casing 8 forms an inlet spout for the primary duct 1a. The casing 8 comprises an annular outer shell 18 and an annular inner shell 19 arranged in the outer shell 18. The outer and inner shells 18, 19 are centered on the longitudinal axis X and connected by radial arms. Each of the outer and inner shells 18, 19 has a first annular edge 18a, 19a, in particular an upstream annular edge 18a, 19a and a second annular edge 18b, 19b, in particular a downstream annular edge 18b, 19b. The first and second annular edges 18a, 19a, 18b, 19b are axially opposed.

The primary duct 1a is delimited downstream of the inlet spout by an inner casing 110 arranged downstream of the outer shell 18 and the inner shell 19.

The secondary duct 1b is also radially delimited by the nacelle 2b and an inter-duct casing 180 arranged radially between the nacelle 2b and the casing 8.

In addition, an inter-duct compartment 1c is arranged radially between the secondary duct 1b and the primary duct 1a. The inter-duct compartment 1c has a first area Z1 delimited internally by the outer shell 18 and externally by the inter-duct casing 180. The inter-duct compartment 1c comprises a second area Z2 downstream of the first area Z1.

In the particular example shown in FIG. 1, the rotor of the low-pressure turbine 7 is connected to the rotor of the low-pressure compressor 3 by a low-pressure shaft 10. The rotor of the high-pressure turbine 6 is connected to the rotor of the high-pressure compressor 4 by a high-pressure shaft 9. The low-pressure shaft 10 is arranged inside the high-pressure shaft 9 in a coaxial manner and extends along the longitudinal axis X.

The low-pressure shaft 10 is guided in rotation by bearings. An intermediate bearing 10a, for example, is arranged radially between the low-pressure shaft 10 and a first bearing support 10b connected, for example, to the inner shell 19. The intermediate bearing 10a is a ball bearing, for example.

The fan 2 is driven in rotation by a fan shaft 11. The fan shaft 11 is connected to the disc for its rotational drive. The fan shaft 11 is supported by a downstream bearing 11a arranged radially between the fan shaft 11 and a second bearing support 11b connected to the inner shell 19. The downstream bearing 11a is for example a ball bearing. It is located upstream of the intermediate bearing 10a. The downstream bearing 11a is arranged on a downstream end of the fan shaft 11.

The fan shaft 11 is also connected to the low-pressure shaft 10 by means of a speed reducer 12. The speed reducer 12 is of mechanical type.

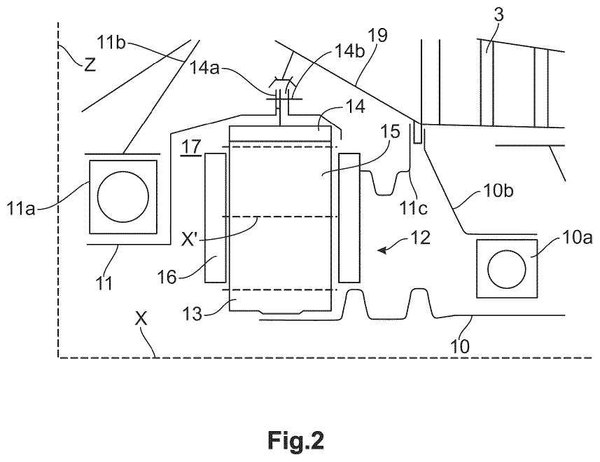

As best seen in FIG. 2, the speed reducer 12 comprises a sun gear 13, a ring gear 14, at least one planet gear 15 that meshes with the ring gear 14 and the sun gear 13, and a planet carrier 16.

The sun gear 13 is coupled in rotation with the low-pressure shaft 10. It forms the inlet of the reducer 12.

The speed reducer 12 advantageously comprises a plurality of planet gears 15. Each planet gear 15 has a central axis X′ parallel to the longitudinal axis X.

The ring gear 14 is annular and is arranged about the longitudinal axis X. According to the example in FIG. 1, the ring gear 14 is coupled in rotation with the fan shaft 11. The ring gear 14 comprises for example an attachment flange 14a connected to the fan shaft 11 for example by means of attachment rods 14b such as screws. The ring gear 14 forms the outlet of the reducer 12.

The planet carrier 16 is stationary in rotation about the longitudinal axis X. The planet carrier 16 is connected to a stationary structure of the turbine engine 1. As shown in the example of FIG. 2, the planet carrier 16 is connected to the inner shell 19, for example via a flexible support 11c.

The speed reducer 12 is made up of gears and rolling bearing that require a lubrication. To this end, lubricating oil is sprayed onto the speed reducer 12. In order to protect the other members of the turbine engine 1 from this oil, the speed reducer 12 is arranged in an annular lubrication enclosure 17. The lubrication enclosure 17 is, for example, an upstream enclosure. The lubrication enclosure 17 is located inside the inner shell 19. The lubrication enclosure 17 is thus defined by the inner shell 19. It may comprise the upstream bearing 11a and the intermediate bearing 10a.

The lubrication enclosure 17 has an enclosure bottom F. The enclosure bottom F is located at the lowest point of the lubrication enclosure 17, i.e. the inner shell 19. The lubricating oil flows by gravity into the enclosure bottom F.

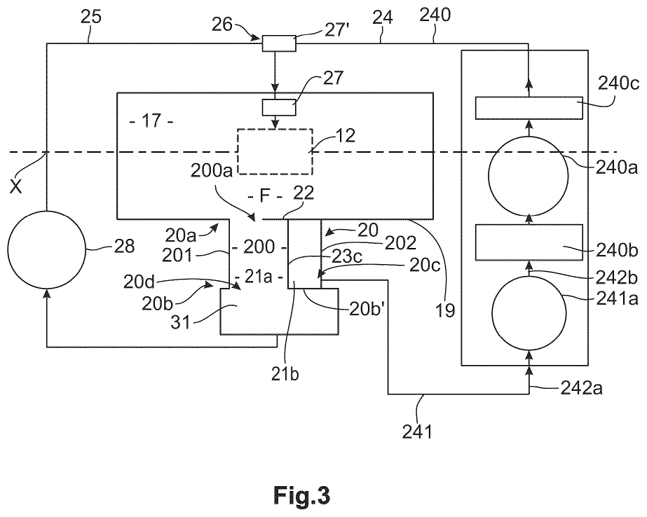

With reference to FIG. 3, among the radial arms extending radially between the outer shell 18 and the inner shell 19, a tubular arm 20 is located at 6 o'clock (six o'clock) by analogy with the corresponding position on the dial of a clock. For simplicity, this 6 h arm will be referred to as the “arm” in the remainder of the description.

The arm 20 comprises a radially internal end 20a connected to the inner shell 19, in particular connected to the lubrication enclosure 17, in particular to the enclosure bottom F.

The radially internal end 20a is open, for example. The arm 20 also comprises a radially external end 20b connected to the outer shell 18 and opposite the radially internal end 20a.

The radially external end 20b, for example, has a bottom wall 20b′ preferably formed by the outer shell 18.

The arm 20 also has a first face and a second face opposite each other and extending radially between the radially external end 20b and the radially internal end 20a. Advantageously, the first and second faces extend axially between the annular edges of the outer and inner shells 18, 19. The first and second faces meet at a first edge 201, in particular an upstream edge 201, and a second edge 202, in particular a downstream edge 202. The upstream and downstream edges 201, 202 are connected axially to each other at their external ends by the bottom wall 20b′.

The arm 20 also comprises an inner cavity 200 comprising a first compartment 21a, in particular an upstream compartment 21a, and a second compartment 21b, in particular a downstream compartment 21b. According to a preferred embodiment of the invention, the arm 20 comprises a radial bulkhead 21 arranged in the inner cavity 200 and which separates the first and second compartments 20a, 20b. The radial bulkhead 21 extends, for example, radially inwards from the bottom wall 20b′. The first and second compartments 21a, 21b each have a predetermined volume.

The first compartment 21a opens into the lubrication enclosure 17 via an oil inlet 200a. The lubricating oil may therefore flow by gravity out of the lubrication enclosure 17 into the arm 20. The oil inlet 200a is provided, for example, in the inner shell 19 and opens into the first compartment 21a.

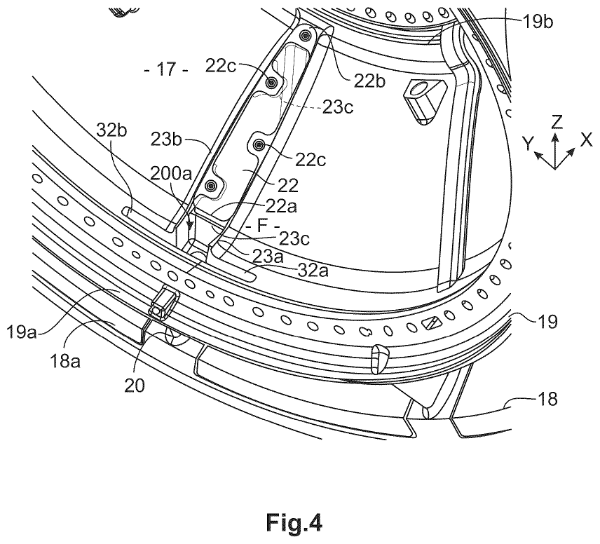

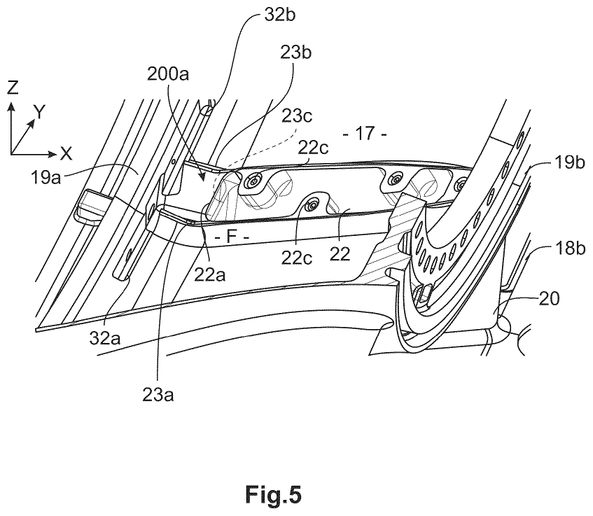

With reference to FIGS. 4 and 5, according to the invention, the oil inlet 200a is delimited circumferentially around the longitudinal axis X by first and second walls 23a, 23b. The first and second walls 23a, 23b are arranged on either side of the oil inlet 200a. The first and second walls 23a, 23b are located in the inner shell 19 and extend radially from the inner shell 19. They extend radially inwards from the inner shell 19. For example, they form a single piece with the inner shell 19. The inner shell 19 and the first and second walls 23a, 23b are made monobloc.

Preferably, the first and second walls 23a, 23b extend radially in the extension of the arm 20, i.e. in the extension of the first and second faces of the arm 20. The first and second walls 23a, 23b extend longitudinally in the inner shell 19. They extend between the first annular edge 19a and the second annular edge 19b, preferably from the first annular edge 19a to the second annular edge 19b of the inner shell 19. The first and second walls 23a, 23b are parallel to each other. The first and second walls 23a, 23b have a height h1 as measured along the radial axis Z which is preferably identical.

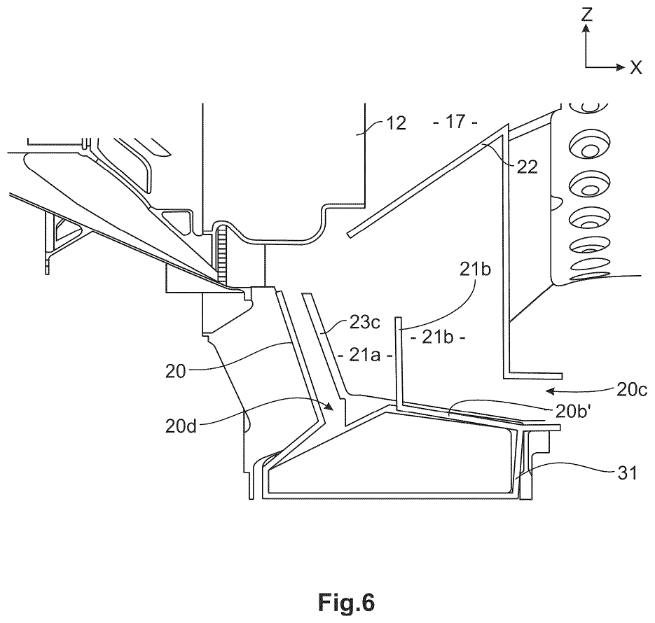

With reference to FIGS. 4 to 6, according to a preferred embodiment of the invention, the oil inlet 200a is delimited axially by a third wall 23c. The third wall 23c is arranged between the first and second walls 23a, 23b. It extends radially inwards from the inner shell 19 and perpendicular to the first and second walls 23a, 23b. The third wall 23c extends radially into the first compartment 21a. It is located upstream of the bulkhead 21.

According to the invention, the second compartment 21b is separated from the lubrication enclosure 17 by a cover 22. The cover 22 thus allows the second compartment 21b to be closed at its internal end so that the oil flows exclusively into the first compartment 21a.

The cover 22 extends longitudinally into the lubrication enclosure 17 from the second annular edge 19b to the oil inlet 200a. The cover 22 thus has an upstream end 22a located on the same side as the oil inlet 200a and an axially opposite downstream end 22b. The third wall 23c is thus offset axially downstream with respect to the upstream end 22a of the cover 22. This further reduces the risk of oil leaking from the lubrication enclosure 17 into the second compartment 21b.

In a preferred embodiment of the invention, the cover 22 is secured to the first and second walls 23a, 23b. The cover 22 is bolted to the first and second walls 23a, 23b. For example, lugs 23c project from the first and second walls 23a, 23b. The lugs 23c of the first wall 23a face the lugs 23c of the second wall 23b. The lugs 23c of the first and second walls 23a, 23b are staggered, for example. The cover 22 is connected to the lugs 23c by bolts 22c.

Advantageously, the cover 22 has a circumferential width equal to a circumferential width of the arm 20. The cover 22 extends circumferentially between the first and second faces of the arm 22. This prevents oil from flowing by gravity into the second compartment 21b. According to a preferred embodiment of the invention, the casing 8 also comprises first and second troughs 32a, 32b arranged on either side of the first and second walls 23a, 23b.

The first and second troughs 32a, 32b are configured to convey oil from the lubrication enclosure 17 towards the oil inlet 200a and thus promote the flow of oil into the first compartment 21a. The first and second troughs 32a, 32b extend from the first and second walls 23a, 23b, opposite the second annular edge 19b of the inner shell 19. They are therefore located on the oil inlet side 200a. The first and second troughs 32a, 32b extend around the longitudinal axis X over an angular sector of between 5° and 10°.

With reference to FIG. 3, the arm 20 further comprises a first oil outlet 20c and a second oil outlet 20d radially opposite the oil inlet 200a. For example, they are provided in the bottom wall 20b′ and/or the downstream edge 202. The first outlet 20c is provided, for example, in the downstream edge 202 and the second outlet 20d is provided, for example, in the bottom wall 20b′.

The first outlet 20c is located in the second compartment 21b, i.e. the downstream compartment 21b, and the second outlet 20d is located in the first compartment 21a, i.e. the upstream compartment 21a. Preferably, the third wall 23c extends as far as the second outlet 20d.

In order to ensure the lubrication of the speed reducer 12 in the lubrication enclosure 17, the turbine engine 1 comprises a lubrication system for lubricating the speed reducer 12.

The lubrication system comprises a main lubrication circuit 24 and an auxiliary lubrication circuit 25, the main and auxiliary circuits 24, 25 being connected to the lubrication enclosure 17. The lubrication system 23 may also comprise a selective spraying device 26 for spraying lubricating oil into the lubrication enclosure 17, this selective spraying device 26 being connected to the main circuit 24 and to the auxiliary circuit 25.

The main circuit 24 typically comprises a supply circuit 240 connecting a main reservoir 240b to the lubrication enclosure 17. The supply circuit 240 comprises a supply pump 240a mounted between the main reservoir 240b and the lubrication enclosure 17, in particular between the main reservoir 240b and the selective spraying device 26. The supply pump 240a, for example, is mechanically driven by the high-pressure shaft 9. Advantageously, the supply pump 240a is connected to the high-pressure shaft 9 by means of an accessory gearbox (AGB). The accessory gearbox is housed in the inter-duct compartment 1c, for example. Thus, when the high-pressure shaft 9 is driven in rotation, it initiates the supply pump 240a which sucks oil from the main reservoir 240b and supplies oil to the selective spraying device 26. The supply circuit 240 may also comprise at least one air/oil exchanger 240c arranged, for example, between the selective spraying device 26 and the supply pump 240a.

The main circuit 24 also comprises a return circuit 241 connecting the main reservoir 240b to the second compartment 21b of the arm 20. The return circuit 241 comprises a recovery pump 241a which is advantageously located in the inter-duct compartment 1c. The recovery pump 241a is connected to the main reservoir 240b and to the first outlet 20c of the arm 20.

In particular, the recovery pump 241 a has an inlet hydraulic line 242a connected to the first outlet 20 c and an outlet hydraulic line 242b which is connected to the main reservoir 240 b.

In some cases, the high-pressure shaft 9 is not driven in rotation or is driven at a rotational speed that is insufficient to drive the supply pump 240a in rotation. For example, when the fan 2 is in free rotation (or auto-rotation, also referred as “windmilling”), or during the start-up or shutdown phases of the turbine engine 1, the supply pump 240a is not primed and is no longer able to supply oil to the selective spraying device 26. The speed reducer 12 is then no longer lubricated by the main circuit 24. In this case, the lubrication of the speed reducer 12 is provided by the auxiliary circuit 25.

The auxiliary circuit 25 is a closed lubrication circuit of the lubrication enclosure 17. It comprises an auxiliary pump 28 connected to an auxiliary reservoir 31 and to the lubrication enclosure 17, in particular to the selective spraying device 26.

The auxiliary reservoir 31 is located outside the outer shell 18. Preferably, the auxiliary reservoir 31 is located in the inter-duct compartment 1c, for example in the first area Z1. As the auxiliary reservoir 31 is located outside the primary duct 1a, the auxiliary reservoir 31 may have a large internal volume without affecting the aerodynamic performance of the turbine engine 1. This means a large volume of oil may be stored.

The auxiliary reservoir 31 is connected to the second oil outlet 20d of the arm 20. In this way, the auxiliary reservoir 31 and the first compartment 21a are connected. The oil flowing by gravity into the first compartment 21a is stored in the auxiliary reservoir 31.

Thanks to the cover 22 of the invention, the auxiliary reservoir 31 is filled as a priority. The risk of under-supplying the auxiliary reservoir 31 with oil is limited. This ensures that the speed reducer 12 is optimally and reliably lubricated whatever the operating phases of the turbine engine 1.

Preferably, the auxiliary reservoir 31 is directly connected to the second oil outlet 20d of the arm 20.

The auxiliary pump 28 is driven, for example, by an electric motor 29. The auxiliary pump 28 and electric motor 29, for example, are located in the inter-duct compartment 1c. The electric motor 29 is supplied with electrical energy by an electrical generator (not shown) located, for example, in the lubrication enclosure 17. The electrical generator supplies electrical energy to the electric motor 29 from mechanical energy. For example, the electrical generator draws mechanical energy from the fan shaft 11. For example, the electric generator is connected to the fan shaft 11 by means of gears 30.

The electric motor is controlled by a control unit 290, for example. The control unit 290 allows to modulate the speed of the auxiliary pump 28 via the electric motor. The control unit is a Full Automatic Digital Engine Control (FADEC), for example.

In another example, the auxiliary pump 28 is driven by the low-pressure shaft 10.

The selective spraying device 26 comprises, for example, a selection member 27′ and at least one sprinkler 27 which is arranged in the lubrication enclosure 17. The selection member 27′ is, for example, a selection valve connected to the main and auxiliary circuits 24, 25.

The sprinkler 27 allows to project lubricating oil into the lubrication enclosure 17. The selective spraying device 26 advantageously comprises two sprinklers 27, a first sprinkler spraying lubricating oil onto the speed reducer 12 and a second sprinkler spraying oil onto the gears 30. The sprinklers are connected to the selection member 27′ and are supplied with lubricating oil by one of the circuits 24, 25 depending on the position of the selection valve.

The operation of the main and auxiliary circuits 24, 25 will now be described.

In a first operating phase, the turbine engine 1 is at a standstill. The main and auxiliary circuits 24, 25 are therefore stopped. In this first phase, the auxiliary reservoir 31 comprises oil remaining from a previous flight.

In a first phase of nominal operation of the turbine engine 1, the auxiliary circuit 25 is inactive, i.e. the auxiliary pump 28 is inactive. The main circuit 24 is active, i.e. the supply pump 240a is active and draws oil from the main reservoir 240b. The oil is conveyed to the lubrication enclosure 17 via the main circuit 24. In this first phase, the lubricating oil flows by gravity into the enclosure bottom F and flows into the arm 20. Thanks to the cover 22, the oil flows preferentially into the first compartment 21a. This oil is stored in the auxiliary reservoir 31. In this phase, the volume of oil in the first compartment 21a is less than the maximum volume of the first compartment 21a. The recovery pump 241a is also active, for example.

In a second nominal operating phase of the turbine engine 1, the main circuit 24 is still active but the volume of oil in the auxiliary reservoir 31 is greater than the maximum volume of the auxiliary reservoir 31 and the maximum volume of the first compartment 21a. The oil is transferred, for example by overflowing, into the second compartment 21b. In this second phase, the recovery pump 241a then sucks oil from the second compartment 21b and allows the oil to circulate in the return circuit 241 of the main circuit 24 to supply oil to the main reservoir 240b.

In a third phase of operation of the turbine engine 1, for example in the event of free rotation of the fan 2 and stoppage or insufficient speed of rotation of the high-pressure shaft 10, the pressure in the main circuit 24 decreases so that the selection member 27′ becomes supplied by the auxiliary circuit 25 wherein the oil pressure is higher. The supply pump 240a is then de-primed or supplies an insufficient flow rate, while the auxiliary circuit 25 is active.

The auxiliary pump 28 draws the oil from the auxiliary reservoir 31 and allows it to circulate in the auxiliary circuit 25 to lubricate the reducer 12 in the lubrication enclosure 17.

Thanks to the invention, it is possible to increase the volume of the auxiliary reservoir 31 without impacting the aerodynamic performance and overall dimensions of the turbine engine 1.

Thanks to the invention, it is possible to guarantee an optimum volume of oil in the auxiliary reservoir 31 for lubricating the speed reducer 12 in the lubrication enclosure 17 in the event of the supply pump 240a of the main circuit 24 being stopped, for example in the event of the fan 2 rotating freely.

1. A casing for an aircraft turbine engine, the casing extending around a longitudinal axis, and comprising:
an inner annular shell centered on the longitudinal axis and internally defining a lubrication enclosure, the inner annular shell having first and second axially opposed annular edges,
an outer annular shell arranged coaxially around the inner annular shell, and
arms extending radially between the inner and outer annular shells, one of the arms, called 6 h arm, being tubular and located at 6 h, the 6 h arm comprising:
a radially external end connected to the outer shell and a radially internal end connected to the inner shell,
an inner cavity comprising a first compartment opening into the lubrication enclosure via an oil inlet provided in the inner shell, and a second compartment,
a first oil outlet located in the second compartment, and
a second oil outlet located in the first compartment, the first and second oil outlets being radially offset from the radially internal end,
wherein the second compartment is separated from the lubrication enclosure by a cover extending longitudinally in the lubrication enclosure from the second annular edge to the oil inlet, and the oil inlet is delimited circumferentially by first and second walls extending radially from the inner shell, on either side of the oil inlet.

2. The casing according to claim 1, wherein the first and second walls extend longitudinally in the inner shell from the first annular edge to the second annular edge.

3. The casing according to claim 1, wherein the oil inlet is axially delimited by a third wall located between the first and second walls and extending radially into the first compartment.

4. The casing according to claim 3, wherein the third wall extends radially to the second oil outlet.

5. The casing according claim 1, further comprising first and second troughs arranged on either side of the first and second walls and configured to convey the oil from the lubrication enclosure towards the oil inlet.

6. The casing according to claim 5, wherein the first and second troughs extend over an angular sector about the longitudinal axis of between 5° and 10°.

7. The casing according to claim 1, wherein the 6 h arm comprises a radial bulkhead arranged in the inner cavity and separating the first compartment from the second compartment.

8. The casing according claim 7, wherein the radially external end of the 6 h arm has a bottom wall wherein the second oil outlet is provided, the bulkhead extending radially towards the inside of the 6 h arm from the bottom wall.

9. A turbine engine for an aircraft, comprising the casing according to claim 1.

10. The turbine engine according to claim 9, further comprising:
a fan driven in rotation about the longitudinal axis by a fan shaft,
a low-pressure shaft connected to the fan shaft by a mechanical speed reducer arranged in the lubrication enclosure, and
a lubrication system for lubricating the speed reducer, the lubrication system comprising a main lubrication circuit and an auxiliary lubrication circuit connected to the lubrication enclosure of said casing, the auxiliary circuit being connected to an auxiliary reservoir, the auxiliary reservoir being located outside the outer shell of said casing, the first oil outlet being connected to the main circuit and the second oil outlet being connected to the auxiliary reservoir.

11. The turbine engine according to claim 10, wherein the auxiliary reservoir is connected directly to the second oil outlet of said casing.

12. The turbine engine according to claim 10, wherein the auxiliary reservoir is housed in an inter-duct compartment which is configured to separate an air flow produced by the fan into a primary flow and a secondary flow.
